(19) United States
(12) Patent Application Publication
(10) Pub. No.: US 2004/0116296 A1
(43) Pub. Date: Jun. 17, 2004

(54) Method for producing the sustained-releasing agricultural chemicals

(76) Inventors: Hae-Jun Park, Daejeon (KR); In-Kuk Lee, Daejeon (KR); Hyun-Suk Shin, Seoul (KR); Mi-Young Rho, Namyangju-si (KR); Nam-Kyu Kim, Daejeon (KR)

Correspondence Address: STAAS & HALSEY LLP, SUITE 700, 1201 NEW YORK AVENUE, N.W., WASHINGTON, DC, 20005, US

(21) Appl. No.: 10/399,567

(22) PCT Filed: Dec. 18, 2001
(86) PCT No.: PCT/KR01/02194

(30) Foreign Application Priority Data
Dec. 19, 2000 (KR) 2000/78670
Jun. 8, 2001 (KR) 2001/32100
Dec. 13, 2001 (KR) 2001/78948

(51) Int. Cl. A01N 57/00; A01N 25/12

(52) U.S. Cl. 504/194; 504/367

(57) ABSTRACT

The invention relates to a method for producing sustained-releasing agricultural chemicals. The effective ingredients of the agricultural chemicals are absorbed into a carrier and are released sustainedly. The effect of a injection last about 30 to 40 days, and the concentration of the agricultural chemicals is enough to have an effect. The agricultural chemicals of this invention may save the farmers' labor, reduce costs caused by continuous injections, and decline environmental contamination as an environmentalfriendly agricultural chemicals.

### TECHNICAL FIELD

The present invention relates to a method for producing sustained-releasing agricultural chemicals containing effective components, more particularly, in which the effective components are adsorbed onto a porous carrier in various modes. The agricultural chemicals of the present invention can control the period releasing the effective components and reduce the harmful damages from the agricultural chemicals.

### BACKGROUND ART

Presently, the agricultural chemicals used for preventing vegetables such as lettuce, cucumber, tomato, fruits, flowering plants, grains and the like from damages by plant pathogen and noxious insects, are usually in a liquid form mixed with water or in a particle form blended with a carrier. In these agricultural chemicals, the effective constituents can be released out of the region easily, make soil acidic or be evaporated and thus be reduced rapidly. Therefore, the duration of effects becomes usually short and the agricultural chemicals should be spread in an excessive amount or in a higher concentration several times than in those recommended. In addition, if the agricultural chemicals are scattered too much, they might affect seriously the health of the users of the agricultural chemicals such as farmers or demanders of farm products. The agricultural chemicals also cause serious environmental pollutions if dispersed and sprinkled continuously, since agricultural chemicals salts are accumulated into soil.

Hence, a number of researches are tried actively to regulate the activation period of the agricultural chemicals and to confer a sustained-releasing property upon the chemicals. Precisely, the agricultural chemicals in a solid form or in a liquid form have been developed to release effective components in a controlled pattern and to sustain the efficacies for a long time, even if it was spread once with a moderate concentration.

In detail, the methods for preparing the sustained-releasing agricultural chemicals have been disclosed as follows. (1) Japanese Patent No. Sho. 58-144304 and Japanese Patent No. Sho. 59-20209 have demonstrated the process for inserting the effective constituents of the agricultural chemicals into a microcapsule. (2) Japanese Patent No. Sho. 58-21602 and Japanese Patent No. Sho. 59-53401 have illustrated the methods for taking the effective components of the agricultural chemicals to cyclodextrin. (3) Japanese Patent No. Sho. 57-126602 and Japanese Patent No. Sho. 60-202801 have disclosed the methods for blending effective constituents of the agricultural chemicals in a particle form or in a powder form independently or with an extender and the like, formulating a particle and then covering the nucleus of the particle with wax or various kinds of resins. Unfortunately, these methods have some problems that the procedures are too complicated and the materials exploited for the method are expensive or have a harmful effect on the environment.

In order to settle the disadvantages, the sustained-releasing agricultural chemicals are required to be composed of favorable material upon environment and are tried to be developed. Japanese Patent No. Hei. 6-116103 has disclosed that the method for conferring the sustained-releasing property upon the pesticide, in which the agricultural chemicals were dissolved with a solvent and introduced to a biodegradable resin molded in a plate form. Japanese Patent No. Hei. 5-85902 has illustrated that the process for preparing the agricultural chemicals, in which the crude material of was mixed with a biodegradable polymer, dissolved in chloroform, adsorbed onto the particular type zeolite and then heated to evaporate chloroform. However, these methods also include complicated procedures and cause environmental problems, since toxic compounds such as organic solvent are utilized for the preparation. Besides, they require a considerable cost to be performed. In addition, U.S. Pat. No. 4,647,537 has demonstrated that the microorganism inhibiting plant diseases was inserted into a carazinane polymer matrix and converted to a biocapsule, but this process is not economical since the polymer material, carazinane as an adsorption agent is too expensive.

On the other hand, the process for coating microorganisms with polysaccharides has been also reported, but this does not consider the sustained-releasing property of agricultural chemicals. Concretely, Korean Patent Application No. 2000-17801 has disclosed that microorganisms can be coated with polysaccharides derived from microorganisms in order to have the heat and the acid resistance. Such a microorganismic coating is to protect microorganisms from gastric acid and other intestinal digestive enzymes. Therefore, the microorganism useful for human body (lactic bacteria and the like) is administered and reaches the small intestine and the large intestine safely. Hence, the microorganismic coating should be resistant to acids, heat and enzymatic digestion and be degraded in specific regions (for example, small intestine and large intestine) immediately. Finally, the microorganism can attach and proliferate onto the small intestine and the large intestine. As described above, the process for coating microorganisms is a completely different field from that for preparing sustained-releasing agricultural chemicals that spread the effective constituents slowly.

### DISCLOSURE OF INVENTION

The object of the present invention is to provide a novel process for preparing sustained-releasing agricultural chemicals to solve the problems of conventional sustained-releasing agricultural chemicals described above, to be harmless for the environment, to enhance the efficacy of the agricultural chemicals and to reduce the human labor and the cost efficiently.

### BRIEF DESCRIPTION OF THE DRAWINGS

The above and other objects, features and other advantages of the present invention will be more clearly understood from the following detailed description taken in conjunction with the accompanying drawings, in which;

FIG. 1 and FIG. 2 represents the effects for preventing red pepper phytophthora blight of the sustained-releasing phosphorous acid salt prepared in the present invention.

### BEST MODE FOR CARRYING OUT THE INVENTION

In order to accomplish the objects, the present invention provides a process for preparing sustained-releasing agricultural chemicals, which comprises: a solution collection step: adding effective components of agricultural chemicals in a ratio of 1˜100 g per 100 ml of solvent, dissolving and collecting a solution containing said effective components; an impregnation drying step: adding a porous carrier in a ratio of 0.5˜2.0 kg per 100 ml of said solution containing said effective components of said agricultural chemicals, mixing homogeneously, drying to form an adsorption carrier containing said agricultural chemicals; and a coating step: adding a suspension containing 0.5˜15 g of polysaccharides obtained from microorganisms per 1 kg of said adsorption carrier containing said effective component of said agricultural compounds dried above. That is to say, the present invention provides a process for preparing a carrier containing said effective constituents of the agricultural chemicals that are coated with polysaccharides.

In the process of the preparation of the present invention, the adsorption of the effective component of the agricultural chemicals and the coating with polysaccharides can be processed coincidently to be simplified additionally.

Concretely, the sustained-releasing agricultural chemicals can be manufactured by the process, which comprises: a dissolution step: adding effective constituents of agricultural chemicals in a ratio of 1˜100 g per 100 ml of solvent and polysaccharides derived from microorganism in a ratio of 0.5˜15 g per 100 ml of solvent, dissolving sufficiently and collecting a polysaccharide solution containing said effective constituents of said agricultural chemicals and an impregnation drying step: adding a porous carrier in a ratio of 0.5˜2.0 kg per 100 ml of said polysaccharide solution, mixing homogeneously, drying into an adsorption carrier containing said agricultural chemicals.

Meanwhile, said solvent can be selected from water or organic solvent properly, depending upon the polarity of effective components in the agricultural chemicals. In addition, the content of the effective components in the agricultural chemicals can be determined relevantly, depending upon the kinds of agricultural chemicals and the specific activity. In the final step, the water content is adjusted to less than 40% to improve the efficiency of working and storing.

The agricultural chemicals prepared by above procedures can release the effective components outside in a sustained pattern, since it is adsorbed onto the carrier uniformly.

The agricultural chemicals of the present invention are also coated with various kinds of polysaccharides onto the surface of the carrier adsorbing the effective components of the agricultural chemicals.

Precisely, the release of effective components are prohibited through two mechanisms of \mathring{1} carrier itself and the adherence of carrier with the effective components, \mathring{2} the membrane coated with polysaccharides.

Therefore, the extrusion of the agricultural chemicals can be regulated efficiently. The sustained-releasing property is also improved, which is convenient for the farmers since it reduces the number of spreading the agricultural chemicals.

As demonstrated above and in other experiments of the inside and the outside, the sustained-releasing agricultural chemicals are identified to maintain the agricultural chemicals with more than effective concentration even after 30˜40 days from one spread.

In the present invention, the agricultural chemicals can include effective components such as insecticidal compounds, fungicidal compounds, herbicidal compounds, plant growth stimulating compounds and the like.

The effective components of the agricultural insecticide in the present invention can be selected among the group comprising acephate, isoxathion, imidacloprid, ethylthiodemeton, ethofenprox, cartap, carbosulfan, clofentezine, cyclopyrifas-methyl, fenbutatin-oxide, cycloprothrin, dimethylrinphos, dimethoate, silafluofen, diazinon, thiodicarb, thiocyclam, tebufenozide, nitenpyram, vamidothion, bifenthrin, pyridaphenthion, pyridaben, pyrimiphos-methyl, fipronil, phenisobromolate, buprofezin, furathiocarb, propafos, bensultap, benfuracarb, formothion, malathon, monocrotophos, BPMC, CVMC, DEP, EPN, MEP, MIPC, MPP, MTMC, NAC, PAP, PHC, PMP, XMC and the like.

The effective components of the fungicides in the present invention can be selected among the group comprising phosphorous acid salt, acibenzolar-S-methyl, azoxystrobin, bitanol, isoprothiolane, isoprodion, iminoctadine triacetate, oxolinic acid, oxone-copper, kasugamycin, carpropamid, captan, dichlomezine, thiabendazole, thifluzamide, tecloftalam, tricyclazole, validamycin, hydroxyisoxazole, pyroquilon, fenarimol, ferimzone, fthalide, blasticidin, polyoxin, methasulfocarb, matalaxyl, metalaxyl-M, metominostrobin, mepronil, ampicilin, CNA, IBP, DF-351, NNf-9425, NNF-9850 and the like.

The effective components of the herbicide and the plant growth stimulant can be selected among the group comprising azimsulfuron, atrazine, ametryn, inabenfide, imazosulfuron, nuiconazole, esprocarb, etobenzanid, oxadiazon, cafenstrole, quizalofop-ethyl, quinclorac, cumylron, chlomethoxynil, cyclosulfamuron, dithiopyr, cinosulfuron, cyhalofop-butyl, simazine, dimetametryn, dimepiperate, cinmethylin, dymron, thenylchor, triapenthenol, naproanilide, paclobutrazol, bifenox, piperophos, pyrazoxyfen, pyrazosulfuron-ethyl, pyrazolate, pyributicarb, pyriminobac-methyl, butachlor, butamifos, pretilachlor, bromobutide, bensulfuron-methyl, benzofenap, bentazon, benthiocarb, pentoxazone, benfuresate, mefenacet, molinate, Jasmon acid (JA), salicylic acid (SA), BABA, BTH, ACN, CNP, 2,4-D, MCPB, MCPB-ethyl and the like and other plant growth stimulating agents.

The various kinds of effective components in the agricultural chemicals can be applied to the agricultural chemicals of the present invention independently, in a proper combination or in a mixture so as to prepare sustained-releasing agricultural chemicals.

Hereinafter, the process for the preparation of the present invention will be illustrated more clearly in accordance with each stage.

Above all, the phosphorous acid salt is known to treat and to prevent plant diseases generated in vegetables such as lettuce, cucumber, tomato and so on, fruits, flowers, grains and the like. However, except the aquatic cultivation, the agricultural chemicals including phosphorous acid salt should be scattered or sprinkled repeatedly. Therefore, it requires human labor and time a lot and is liable to provoke environmental pollutions as a result of its excessive uses.

In the present invention, the phosphorous acid salt is adopted as an effective component of the sustained-releasing agricultural chemicals. The process for preparing the agricultural chemicals of the present invention will be illustrated clearly with the reference of the useful compound. Although the phosphorous acid salt is selected in this case, it is natural in the physicalchemical principles that other agricultural effective components can be applied to obtain the similar agricultural chemicals.

### (1) Coating After the Adsorption of Effective Component

In the present invention, various processes can be applied to prepare the phosphorous acid salt.

First, 10˜100 g of phosphorous acid (H₃PO₃) is dissolved with 100˜300 ml of distilled water and potassium hydroxide is added slowly in a small amount so that pH is adjusted to 5.5˜6.5. As a result, the solution of phosphorous acid salt is prepared. At that this moment, the concentration of phosphorous acid salt is in the range of about 10,000˜100,000 ppm, which is about 100˜1,000 times higher than that of conventional phosphorous acid salt, 100˜1,000 ppm. This is applied to other agricultural chemicals in the same ratio.

Then, 100˜300 ml solution of the phosphorous acid salt is added and mixed uniformly with 0.5˜2.0 kg of porous carriers. The resultant mixture is dried at 25˜150° C. with adjusting the water content to less than 40%. Then, 1 kg of the phosphorous acid salt carrier dried above is added and mixed with the suspension containing polysaccharides derived from microorganism homogeneously and dried at 25˜150° C. with adjusting the water content to less than 40%. Consequently, the effective components of the agricultural chemicals are adsorbed onto the porous carrier and the sustained-releasing agricultural chemicals coated with polysaccharides can be obtained.

At that time, the porous carrier for adsorbing agricultural effective components can be one substance or a mixture of more than two substance selected from the group comprising zeolite, pearlite, vermiculite, diatomite, ceramic and activated charcoal. These materials are natural and comprise main components of soil amendment agents and those of excipients and extenders that are used frequently to prepare agricultural chemicals. Besides, any substance can be utilized for the carrier if it is harmless for the environment and soil. The carrier can be natural or artificial. The latter is purified to remove internal contaminants and to heat original stone at more than 600° C. in order to make the internal state of the carrier best. The carrier used in the present invention has a diameter in the range of 0.5˜5 mm and preferably, in more than 2 mm, which makes the treatment easy as well as enhances the efficacy since the agricultural chemicals are not scattered in the air and is fallen to soil.

In addition, the polysaccharides derived from microorganisms is one substance or a mixture of more than two substances selected among the group comprising curdlan, levan, xanthangum, pullulan, polysaccharide-7, cellulose, zooglan, gellan and the like.

In the present invention, the polysaccharide coating can be performed once or several times repeatedly, depending upon the kinds of effective components, the chemicals property and the sustained-releasing property.

### (2) Coating with a Coating Agent Containing Effective Components

The other kinds of the sustained-releasing agricultural chemicals in the present invention can be prepared by process as follows.

First, 8.3 g of potassium hydroxide and 2.5 g of polysaccharides derived from microorganism are added to 200 ml of distilled water, mixed by stirring and dissolved sufficiently. Then, 10 g of phosphorous acid is added and mixed sufficiently so as to make a colloidal solution containing polysaccharides. 1 kg of zeolite with 0.5˜5 mm of diameter is added, mixed homogeneously and immersed in a humid condition. Then, the resultant is dried at 80° C. with hot air. At this moment, the porous carrier adsorbing other effective components of the pesticides previously can be utilized.

As a result, the phosphorous acid and other constituents of agricultural chemicals can obtain the sustained-releasing property coincidently. The water content is preferable to be adjusted to less than 40%.

The sustained-releasing agricultural chemicals prepared by the process described above are adsorbed onto the porous carrier with the effective components in the high concentration. Compared with the case of only agricultural chemicals excluding the carrier, this prevents outstandingly the effective components from being scattered outside on basis of the carrier structure. As a result, the sustained-releasing property can be conferred primarily to the agricultural chemicals of the present invention. In addition, the sustained-releasing agricultural chemicals prepared above are coated again with natural polysaccharides onto the surface of the carrier adsorbing the effective component. Otherwise, the polysaccharides containing the effective component is coated and adsorbed onto the carrier. Therefore, the combination of the effective component and the carrier can form one body and be degraded slowly in the natural environment. Consequently, the sustained-releasing property can be conferred secondarily to the agricultural chemicals of the present invention.

### PREFERRED EMBODIMENTS

Practical and presently preferred embodiments of the present invention are illustrative as shown in the following Embodiments.

However, it will be appreciated that those skilled in the art, on consideration of this disclosure, may make modifications and improvements within the scope of the present invention.

For the convenience, the phosphorous acid salt is utilized as an effective component of the agricultural chemicals. Zeolite is used as a carrier and beta-glucan, pestan and curdlan are adopted as coating substances derived from microorganism. However, the effective components of the agricultural chemicals, the carriers and the coating agents described above are examples and other equivalent substances can be applied to the same purpose. It is also clear to those skilled in this art that the combination of more than two substances can be applied in the process of the present invention.

### <Comparative Embodiment 1> Preparation of Non-Sustained-Releasing Agricultural Chemicals

In order to prepare non-sustained-releasing agricultural chemicals, the effective component was adsorbed onto carriers and dried.

50 g of phosphorous acid was dissolved with 100 ml of distilled water and potassium hydroxide was added in a small amount so as that pH was adjusted to 5.5. 100 ml solution of phosphorous acid salt prepared above was added and mixed homogeneously with 1 kg of zeolite having 0.5˜5 mm of diameter. Then the resultant was adsorbed and dried with hot air at 100° C. to be non-sustained-releasing agricultural chemicals.

### <Preferred Embodiment 2> Preparation of Sustained-Releasing Agricultural Chemicals Coated with Polysaccharides Derived from Microorganism

In order to prepare sustained-releasing agricultural chemicals of the present invention, the effective component was adsorbed onto the carrier, coated with polysaccharides derived from microorganism and dried.

10 g of phosphorous acid was dissolved with 100 ml of distilled water and potassium hydroxide was added slowly in a small amount so as that pH was adjusted to 5.5. 100 ml solution of phosphorous acid salt prepared above was added and mixed homogeneously with 1 kg of zeolite having 0.5˜5 mm of diameter. Then the resultant was immersed in a humid condition and dried with a hot air at 100° C. As a result, the effective component of the agricultural chemicals was fixed onto the zeolite. At this moment, the water content was adjusted to less than 40%.

1 kg of the phosphorous acid salt carrier prepared above was mixed uniformly with 50 ml of the solution in a gel state containing beta-glucan of 1,000,000 average molecular weight and 5 g of pestan powder and dried at 100° C. with hot air. Then, the carrier coated primarily was mixed again with 50 ml of curdlan or pestan suspension uniformly and dried with a hot air at 100° C. to be the sustained-releasing agricultural chemicals of the present invention.

### <Preferred Embodiment 3> Preparation of Sustained-Releasing Agricultural Chemicals Coated with Polysaccharides Derived from Microorganism and Containing the Effective Component of Agricultural Chemicals

In order to prepare sustained-releasing agricultural chemicals of the present invention, the carrier was coated with polysaccharides derived from microorganism and containing the effective pesticidal component and dried.

8.3 g of potassium hydroxide and 2.5 g of curdlan were added to 200 ml of distilled water, mixed by stirring and dissolved sufficiently. Then, 10 g of phosphorous acid was added and mixed completely so as to make a polysaccharide solution in a colloid form. Then, 1 kg of zeolite with 0.5˜5 mm of diameter was added, mixed homogeneously and immersed in a humid condition. Again, the resultant was dried at 100° C. with a hot air and curdlan containing the effective component of the pesticides was coated onto the zeolite. At that time, the water content was adjusted to less than 40%.

### <Application Embodiment 1> Examination of Sustained-Releasing 0 Agricultural Chemicals for Release in an Aquatic Condition

The sustained-releasing agricultural chemicals prepared in the present invention released its effective component only in the aquatic condition by dissolving. Commonly, in the agricultural farm, water was sprinkled about every 3 days. About two hours after sprinkling, the water evaporated or absorbed into crops or soil. Consequently, the moisture was eliminated not to release the sustained-releasing agricultural chemicals. Namely, the sustained-releasing agricultural chemicals prepared in the present invention were identified to extrude its effective components about every three days and two hours toward outer environment.

In order to elucidate the sustained-releasing property of the agricultural chemicals prepared in the present invention, the aquatic release property was experimented in the same condition as that of the practical use.

Concretely, 1 g of the sustained-releasing agricultural chemicals prepared above was mixed with 1 ml of water and stored for 2 hours. Then the supernatant containing the pesticidal component was recovered and the concentration of phosphorous acid was measured by performing the High Pressure Liquid Chromatography (HPLC) (See Table 1: unit, ppm). This procedure was repeated so that the practical experimental condition corresponded to that of the sprinkling once.

As illustrated in Table 1, the result was clear that the non-coated phosphorous carrier in the non-sustained-releasing agricultural chemicals (Comparative Embodiment 1) were released relatively much in the initial state, but the coated carrier (Preferred Embodiment 2 and Preferred Embodiment 3) has shown the outstanding sustained-releasing effect. Comparing the effects, the non-sustained-releasing type maintained only 10˜15% of the efficacy, about 2˜3 days after being scattered or sprinkled. The coated phosphorous salt carrier containing the effective component and the carrier (Preferred Embodiment 3) coated with polysaccharides containing the effective component were identified to release slowly the phosphorous acid in more than 100 ppm, the relatively constant concentration toward sprinkling 10 times, although they had some differences. To the contrary, the non-coated product (Comparative Embodiment 1) was confirmed not to have the sustained-releasing property completely.

The release of phosphorous acid was caused in a constant ratio about more than 10 times was considered and common agricultural farms were assumed to sprinkle every 3 days. The sustained-releasing agricultural chemicals of the present invention (Preferred Embodiment 2 and Preferred Embodiment 3) were deduced to maintain its pharmaceutical efficacy for about 30 days possibly.

TABLE 1

| No. | 1 | 2 | 3 | 4 | 5 | 6 | 7 | 8 | 9 | 10 |
|---|---|---|---|---|---|---|---|---|---|---|
| Comparative | 3445 | 1307 | 556.1 | 137.6 | 52.59 | 28.47 | 22.02 | 18.36 | 15.42 | 12.6 |
| Embodiment 1 | | | | | | | | | | |
| Preferred | 2719 | 1507 | 1093 | 415.7 | 260.3 | 228.8 | 170.2 | 153.5 | 145.1 | 142.3 |
| Embodiment 2 | | | | | | | | | | |
| (glucan coating) | | | | | | | | | | |
| Preferred | 2979 | 1570 | 1316 | 635.4 | 331.6 | 172.2 | 142.5 | 148.4 | 137.4 | 134.5 |
| Embodiment 2 | | | | | | | | | | |
| (pestan coating) | | | | | | | | | | |
| Preferred | 2820 | 1630 | 1120 | 382.4 | 240.2 | 260.4 | 201.4 | 172.4 | 153.1 | 163.0 |
| Embodiment 3 | | | | | | | | | | |

### <Application Embodiment 2> Examination of the Storage for Sustained-Releasing Agricultural Chemicals

In order to determine the available period of the sustained-releasing agricultural chemicals prepared in the present invention, its effective component was examined to determine the time it can be maintained. In the practical field, the sustained-releasing agricultural chemicals used to be stored for several months, if long, before the use.

The agricultural products prepared in Comparative Embodiment 1 and Preferred Embodiment 3 was stored in the conventional plastic baskets not covered closely with the capping and maintained at room temperature. After 15 days and after 3 months from the preparation respectively, 0.5 g of the products were obtained, mixed with 2 ml of water and maintained for 2 hours. Then, the supernatants containing the agricultural chemicals were recovered by using HPLC and were exploited to measure the concentrations of phosphorous acid (See Table 2: unit, ppm).

TABLE 2

| | After 15 days | After 3 months |
|---|---|---|
| Comparative | 119 | 68 |
| Embodiment 1 | | |
| Preferred | 295 | 284 |
| Embodiment 3 | | |

As a result, the sustained-releasing agricultural chemicals prepared in Preferred Embodiment 3 were identified to retain the content of the effective component in about 2.4 times after 15 days from the manufacture and in about more than 4.0 times after 3 months, comparing with that prepared in Comparative Embodiment 1.

The experimental procedure adopted in Application Embodiment 2 used to be performed with the dilution of 4 times than the procedure in Application Embodiment 1. Therefore, in order to analyze the results simply with that of Application Embodiment 1, the concentration was multiplied by four. At that time, the agricultural chemicals prepared in Preferred Embodiment 3 had the release concentration of 1136 ppm (=284×4) after 3 months, which was the similar value to that obtained from the release experiment right after the preparation 3 times.

Consequently, the sustained-releasing agricultural chemicals prepared by the process of the present invention was identified to maintain the effective component in more than the preferred effective contents, even if stored for a long time.

### <Application Embodiment 3> Examination of Sustained-Releasing Agricultural Chemicals in Field

In order to examine the practical efficacies of the sustained-releasing agricultural chemicals prepared in the present invention, the experiment was performed in the field out of the laboratory.

### (1) Examination of Preventive Effects on Cucumber Powdery Mildew Disease in Field

The experiment was performed in order to examine the preventive effects on cucumber powdery mildew disease in the cucumber green house situated in Kimhae. The cucumber was sowed in Sep. 6, 2000, treated with the pesticide in Sep. 26, 2000. The status of the powdery mildew disease was measured on Oct. 12, 2002 to detect the generation ratio of the disease. In this experiment, the plant pathogenic fungi of the powdery mildew disease were not inoculated artificially and the preventive effect on the naturally generated powdery mildew disease was detected (See Table 3).

Three experimental groups were adopted for the examination as followed and for each group 250 plants of cucumber were allotted. Concretely, they were composed of the control group which was not treated with phosphorous acid salt, and the comparative group which treated with 100 ppm of agricultural chemicals made of phosphorous acid salt in a liquid type around the region adjacent to soil and stem in Sep. 26, 2000 and Oct. 4, 2000 respectively toward cucumber in 20 ml per one plant. The last group was the experimental group which was treated with the sustained-releasing agricultural chemicals composed of phosphorous acid salt and prepared by the process of Preferred Embodiment 2 in 1 g per one plant and the like.

In order to measure the preventive effect of disease and the disease generation frequency, fungi which appeared on the cucumber leaves with the similar shape to the white powder were recognized in naked eyes. Concretely, the standard manuals of the agricultural chemicals efficacy experiment published from National Institute of Agricultural Science and Technology were referred to. The antifungal activity against cucumber powdery mildew was examined by exploiting the method for the infection percentage of the pesticide field efficacy experiment.

TABLE 3

| | Frequency (%) | Relative prevention (%) |
|---|---|---|
| Control group | 30.2 | 0.0 |
| Comparative group | 12.9 | 57.3 |
| Preferred Embodiment 2 | 5.1 | 83.1 |

The non-treated control group had a low infection percentage as demonstrated in Table 3, since the powdery mildew was not caused artificially, but naturally. All the groups treated with the agricultural chemicals of the present invention were identified to reduce the infection to more than 50%. Especially, the sustained-releasing agricultural chemicals coated with curdlan prepared in Preferred Embodiment 2 were identified to have the additional preventive effect in more than 25%, compared with that of the comparative group.

### (2) Examination of Preventive Effects for Artificial Tomato Late Blight

The preventive effect of the agricultural chemicals prepared in the present invention was examined in the tomato green house situated in Kimhae. The experiment was performed by inoculating plant pathogenic fungi, Phytophthora infestans, artificially.

The mini tomato (Variety “koko”) was sowed in Jan. 2, 2001, treated with the agricultural chemicals in Feb. 9, 2001 when reaching a 2˜4 leaf stage and sprinkled to each tomato plant with 10 ml of the zoospore suspension in 4×10³ of the spore concentration at 5 p.m. during the period of March, 23-27. The Phytophthora infestans was made to zoospores by stressing with humidity during the cultivation and utilized.

Five experimental groups were adopted for the examination as followed. For each group 12 plants of tomato were allotted. Concretely, the experimental groups were composed of the control group which was not treated with phosphorous acid salt, the comparative group which was treated with 100 ppm of agricultural chemicals made of phosphorous acid salt in a liquid state around the region adjacent to soil and stem toward tomatoes in 25 ml per one plant and the experimental groups which were treated with the sustained-releasing agricultural chemicals prepared by the process of Comparative Embodiment 1, Preferred Embodiment 2 (curdlan coating) and Preferred Embodiment 3 in 1 g per one plant and the like.

The infection frequency of the tomato late blight was calculated in Apr. 12, 2001 and the preventive effect against the tomato late blight was detected in each group (See Table 4).

As illustrated Table 4, in case of the agricultural chemicals prepared in the present invention 80˜98 % of the preventive effect was observed since the release of the effective component was controlled properly. Especially, the sustained-releasing agricultural chemicals of the present invention were identified to have the additional preventive effect in about more than 50%, compared with that of the comparative group that was not treated for the sustained-releasing property.

TABLE 4

| | | | | | | | | Preven- |
|---|---|---|---|---|---|---|---|---|
| | | | | | | | | tive |
| | Disease severity index | | | | | Frequency | Frequency | Value |
| | 0 | 1 | 2 | 3 | 4 | (plant) | (%) | (%) |
| Control group | 1 | 1 | 2 | 2 | 6 | 11 | 72.92 | 0.0 |
| Comparative | 1 | 3 | 2 | 3 | 3 | 11 | 58.33 | 20.0 |
| group | | | | | | | | |
| Preferred | 8 | 2 | 1 | 1 | 0 | 4 | 14.58 | 80.0 |
| Embodiment 2 | | | | | | | | |
| (curdlan) | | | | | | | | |
| Preferred | 7 | 4 | 1 | 0 | 0 | 5 | 12.50 | 82.9 |
| Embodiment 3 | | | | | | | | |

### (3) Examination of Preventive Effect on Artificial Red Pepper Phytophthora Blight

The preventive effect of the sustained-releasing agricultural chemicals prepared in the present invention was examined in the green house. The experiment was performed by inoculating the plant pathogenic fungi, Phytophthora capsici, artificially.

The pepper seed was sowed in Nov. 10, 2001 and treated with the effective component of the agricultural chemicals in Nov. 17, 2001.

Two experimental groups were adopted for the examination as followed. Concretely, the control group was not treated with phosphorous acid salt and was composed of 56 plants. The experimental group was treated with the sustained-releasing agricultural chemicals prepared by the process of Preferred Embodiment 3 in 1 g per one plant and was composed of 49 plants. In Nov. 26, 2001, 5 ml of the zoospore suspension in 5×10³ cfu/ml of the concentration was sprinkled to each pepper plant. After 5 days from the pathogen inoculation, the disease infection was observed in naked eyes in Dec. 1, 2001 (See Table 5).

Through the entire experimental procedure, water was sprinkled sufficiently in a 2-day interval and the room temperature was maintained at 26° C.

TABLE 5

| | | | Relative |
|---|---|---|---|
| | No. of disease/ | Frequency | Prevention |
| | No. of treated plants | (%) | (%) |
| Contol group | 19/56 | 33.9 | 0.0 |
| Preferred | 0/49 | 0.0 | 100 |
| Embodiment 3 | | | |

As illustrated in Table 4, in case of the agricultural chemicals prepared in the present invention the effective component cannot be released even in sprinkling repeatedly (about 7 times). As a result, the release of the effective component was controlled properly and the preventive effects were detected to be complete.

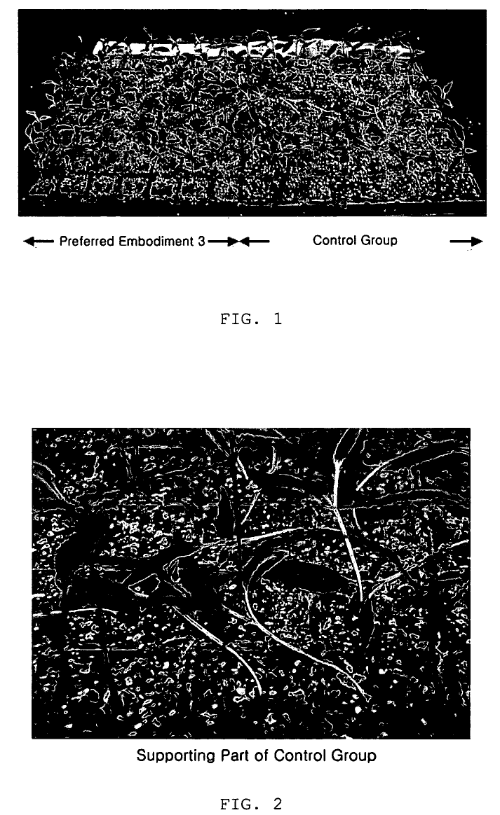

The experimental results were depicted in FIG. 1 and FIG. 2. As shown in the figures, the non-treated control group became weaken and smaller in the supporting part due to the disease and cannot support the stem. To the contrary, the experimental group treated with the sustained-releasing agricultural chemicals was never deformed like above.

Consequently, though the sustained-releasing agricultural chemicals can be scattered once, it become more effective than the conventional agricultural chemicals scattered twice. Therefore, the sustained-releasing agricultural chemicals were confirmed to have more outstanding preventive effect as well as to reduce manpower and cost in the agricultural farm efficiently.

### Industrial Applicability

As demonstrated clearly and confirmed above, the present invention relates to a process for preparing sustained-releasing agricultural chemicals in which agricultural chemicals are adsorbed onto porous carriers in various modes. The sustained-releasing agricultural chemicals of the present invention can maintain the efficacy for about 30˜40 days per sprinkling once. Therefore, the effective component can be released continuously in a proper and inexcessive concentration and have outstanding preventive effects.

The sustained-releasing agricultural chemicals can be utilized to reduce human labor, to decrease economical damages due to successive sparkling and to prevent the environmental pollution. In addition, the sustained-releasing agricultural chemicals can be applied to the large soil cultivation than the water cultivation as an environment-friendly pesticide.

What is claimed is:

1. A process for preparing sustained-releasing agricultural chemicals containing phosphorous acid salt, which comprises:
a solution collection step: adding an effective component of agricultural chemicals in a ratio of 1˜100 g per 100 ml of solvent, dissolving and collecting a solution containing said effective component;
an impregnation drying step: adding a porous carrier in a ratio of 0.5˜2.0 kg per 100 ml of said solution containing said effective component of said agricultural pesticide, mixing homogeneously, drying to form an adsorption carrier containing said effective component; and,
a coating step: adding a suspension containing 0.5˜15 g of polysaccharides obtained from microorganism per 1 kg of said adsorption carrier containing said effective component of said agricultural chemicals dried above.

2. A process for preparing sustained-releasing agricultural chemicals, which comprises:
a dissolution step: adding an effective component of agricultural chemicals in a ratio of 1˜100 g per 100 ml of solvent and polysaccharides derived from microorganism in a ratio of 0.5˜15 g per 100 ml of solvent, dissolving sufficiently and collecting a polysaccharide solution containing said effective component of said agricultural chemicals; and,
an impregnation drying step: adding a porous carrier in a ratio of 0.5˜2.0 kg per 100 ml of said polysaccharide effective component containing solution, mixing homogeneously, drying to form an adsorption carrier containing said effective component of agricultural chemicals.

3. The process for preparing sustained-releasing agricultural chemicals according to claim 1 or claim 2, in which an effective component is one substance or a mixture of more than two substances selected from the group comprising phosphorous acid salt, acephate, isoxathion, imidacloprid, ethylthiodemeton, ethofenprox, bitanol, cartap, carbosulfan, clofentezine, cyclopyrifas-methyl, fenbutatin-oxide, cycloprothrin, dimethylrinphos, dimethoate, silafluofen, diazinon, thiodicarb, thiocyclam, tebufenozide, nitenpyram, vamidothion, bifenthrin, pyridaphenthion, pyridaben, pyrimiphos-methyl, fipronil, phenisobromolate, buprofezin, furathiocarb, propafos, bensultap, benfuracarb, formothion, malathon, monocrotophos, BPMC, CVMC, DEP, EPN, MEP, MIPC, MPP, MTMC, NAC, PAP, PHC, PMP, XMC, acibenzolar-S-methyl, azoxystrobin, isoprothiolane, isoprodion, iminoctadine triacetate, oxolinic acid, oxone-copper, kasugamycin, carpropamid, captan, diclomezine, thiabendazole, thifluzamide, tecloftalam, tricyclazole, validamycin, hydroxyisoxazole, pyroquilon, fenarimol, ferimzone, fthalide, blasticidin, polyoxin, methasulfocarb, matalaxyl, metalaxyl-M, metominostrobin, mepronil, ampiciline, CNA, IBP, DF-351, NNF-9425, NNF-9850, azimsulfuron, atrazine, ametryn, inabenfide, imazosulfuron, nuiconazole, esprocarb, etobenzanid, oxadiazon, cafenstrole, quizalofop-ethyl, quinclorac, cumylron, chlomethoxynil, cyclosulfamuron, dithiopyr, cinosulfuron, cyhalofop-butyl, simazine, dimetametryn, dimepiperate, cinmethylin, dymron, thenylchor, triapenthenol, naproanilide, paclobutrazol, bifenox, piperophos, pyrazoxyfen, pyrazosulfuron-ethyl, pyrazolate, pyributicarb, pyriminobac-methyl, butachlor, butamifos, pretilachlor, bromobutide, bensulfuron-methyl, benzofenap, bentazon, benthiocarb, pentoxazone, benfuresate, mefenacet, molinate, Jasmon acid (JA), salicylic acid (SA), BABA, BTH, ACN, CNP, 2,4-D, MCPB and MCPB-ethyl.

4. The process for preparing sustained-releasing agricultural chemicals according to claim 1 or claim 2,
in which said porous carrier is one substance or a mixture of more than two substances selected from the group comprising zeolite, pearlite, vermiculite, diatomite, ceramic and activated charcoal.

5. The process for preparing sustained-releasing agricultural chemicals according to claim 1 or claim 2, in which said polysaccharide derived from microorganism is one substance or a mixture of more than two substances selected among the group comprising pestan, levan, zanthangum, pullulan, polysaccharide-7, cellulose, zooglan, gelan and curdlan.
